(19) United States
(12) Patent Application Publication
(10) Pub. No.: US 2026/0018838 A1
(43) Pub. Date: Jan. 15, 2026

(54) CONNECTOR AND CONNECTOR FIXING STRUCTURE

(71) Applicant: SUMITOMO WIRING SYSTEMS, LTD., Mie (JP)

(72) Inventor: Takeshi MISU, Mie (JP)

(21) Appl. No.: 18/994,610

(22) PCT Filed: Jun. 29, 2023
(86) PCT No.: PCT/JP2023/024139

§ 371 Date: Jan. 15, 2025

(30) Foreign Application Priority Data
Jul. 20, 2022 (JP) 2022-115717

(51) Int. Cl. H01R 13/6593; H01R 4/34; H01R 13/512; H01R 13/73

(52) U.S. Cl. CPC H01R 13/6593; H01R 4/34; H01R 13/512; H01R 13/73

(57) ABSTRACT

A connector housing to be fixed to an electrically conductive enclosure includes an outer arrangement portion to be arranged outside the enclosure and an inner arrangement portion to be arranged inside the enclosure. A shield shell includes a first part to be arranged inside the outer arrangement portion and a second part to be arranged at a position shifted from the first part in a direction opposite to a first direction. The first part includes a first connecting portion and a second connecting portion to be electrically connected to an electromagnetic shield member of the wire and covers an outer periphery of a part of the wire to be arranged inside the outer arrangement portion. The second part includes a second shield connecting portion to be fixed and electrically connected to the enclosure inside the enclosure.

### TECHNICAL FIELD

The present disclosure relates to a connector and a connector fixing structure.

### BACKGROUND

Conventionally, a connector is known which is mounted on an electrically conductive enclosure of a device to be installed in a vehicle such as an automotive vehicle. Such a connector includes, for example, a connector housing, a terminal to be held in the connector housing and a shield shell for suppressing the emission of electromagnetic noise from the connector. A wire is connected to the terminal. The wire is pulled out from the connector housing.

For example, in a connector described in Patent Document 1, a shield shell is arranged outside a connector housing. The shield shell includes a shell body for covering the outer surface of the connector housing and a bolt fixing portion extending from the shell body. A shield ring is mounted on the shell body to fix a braided wire for covering the outer periphery of the wire by sandwiching the braided wire between the shell body and the shield ring. The braided wire is electrically connected to the shield shell by contacting the outer peripheral surface of the shell body between the shield ring and the shell body. Further, an enclosure of a device has a connector mounting surface and a bolt fixing surface orthogonal to the connector mounting surface. The bolt fixing portion includes a part extending along the connector mounting surface and a part extending along the bolt fixing surface. The bolt fixing portion is fixed to the enclosure by a bolt mounted on the bolt fixing surface. In this way, the shield shell is electrically connected to the enclosure.

### PRIOR ART DOCUMENT

### Patent Document

Patent Document 1: JP 2016-076438 A

### SUMMARY OF THE INVENTION

### Problems to be Solved

In the case of fixing the connector described in Patent Document 1 to the enclosure, a connected part of the shield shell and the braided wire and an electrically connected part of the shield shell and the enclosure are exposed to the outside of the enclosure and the connector. Thus, if the device is arranged in a place having a possibility of being wetted, water may adhere to the connected part of the shield shell and the braided wire and the electrically connected part of the shield shell and the enclosure. If water adheres to the connected part of the shield shell and the braided wire, the electrical connection of the shield shell and the braided wire possibly becomes unstable. Similarly, if water adheres to the connected part of the shield shell and the enclosure, the electrical connection possibly becomes unstable. Thus, there is a concern that electromagnetic shielding performance is reduced.

The present disclosure aims to provide a connector and a connector fixing structure capable of suppressing a reduction in electromagnetic shielding performance.

### Means to Solve the Problem

A connector of the present disclosure is provided with a connector housing to be fixed to an electrically conductive enclosure of a device, a terminal to be held in the connector housing, a wire to be electrically connected to the wire and pulled out to outside from inside of the connector housing along a first direction, and an electrically conductive shield shell, the wire being a shielded wire including a core wire, a first insulation coating covering an outer periphery of the core wire, an electrically conductive electromagnetic shield member covering an outer periphery of the first insulation coating and a second insulation coating covering an outer periphery of the electromagnetic shield member, the connector housing including an outer arrangement portion to be arranged outside the enclosure and an inner arrangement portion to be arranged inside the enclosure, the shield shell including a first part to be arranged inside the outer arrangement portion and a second part arranged at a position shifted from the first part in a direction opposite to the first direction, the first part including a first shield connecting portion to be electrically connected to the electromagnetic shield member, the first part covering an outer periphery of a part of the wire to be arranged inside the outer arrangement portion, the second part including a second shield connecting portion to be fixed and electrically connected to the enclosure inside the enclosure, and the second shield connecting portion being located inside an outer edge of the connector housing when viewed from the first direction.

A connector fixing structure of the present disclosure is provided with an electrically conductive enclosure of a device, a connector housing for holding a terminal and a wire electrically connected to the terminal and pulled out along a first direction, and an electrically conductive shield shell, the enclosure including a mounting opening, the terminal being inserted through the mounting opening, and a shield shell connecting portion provided inside the enclosure, the connector housing including an outer arrangement portion to be arranged outside the enclosure and an inner arrangement portion to be arranged inside the enclosure, the outer arrangement portion including a fixing portion to be fixed to an outer surface of the enclosure, the wire being a shielded wire including a core wire, a first insulation coating covering an outer periphery of the core wire, an electrically conductive electromagnetic shield member covering an outer periphery of the first insulation coating and a second insulation coating covering an outer periphery of the electromagnetic shield member, the shield shell including a first part to be arranged inside the outer arrangement portion and a second part to be arranged inside the enclosure together with the inner arrangement portion, the first part including a first shield connecting portion to be electrically connected to the electromagnetic shield member, the first part covering an outer periphery of a part of the wire to be arranged inside the outer arrangement portion, the second part including a second shield connecting portion, and the second shield connecting portion being located inside an outer edge of the connector when viewed from the first direction, the second shield connecting portion being fixed and electrically connected to the shield shell connecting portion inside the enclosure.

### Effect of the Invention

According to the connector and the connector fixing structure of the present disclosure, a reduction in electromagnetic shielding performance can be suppressed.

### BRIEF DESCRIPTION OF THE DRAWINGS

FIG. 1 is a section of a connector in a state fixed to an enclosure in one embodiment.

FIG. 2 is an exploded perspective view of the connector shown in FIG. 1.

FIG. 3 is a plan view of the connector shown in FIG. 1 when viewed from a fixing surface to the enclosure.

FIG. 4 is a perspective view showing a third housing, a terminal, a shield shell and a wire provided in the connector shown in FIG. 1.

FIG. 5 is a section enlargedly showing a part of the connector shown in FIG. 1.

FIG. 6 is a section enlargedly showing a part of the connector shown in FIG. 1.

### DETAILED DESCRIPTION TO EXECUTE THE INVENTION

### Description of Embodiments of Present Disclosure

First, embodiments of the present disclosure are listed and described.
[1] The connector of the present disclosure is provided with a connector housing to be fixed to an electrically conductive enclosure of a device, a terminal to be held in the connector housing, a wire to be electrically connected to the wire and pulled out to outside from inside of the connector housing along a first direction, and an electrically conductive shield shell, the wire being a shielded wire including a core wire, a first insulation coating covering an outer periphery of the core wire, an electrically conductive electromagnetic shield member covering an outer periphery of the first insulation coating and a second insulation coating covering an outer periphery of the electromagnetic shield member, the connector housing including an outer arrangement portion to be arranged outside the enclosure and an inner arrangement portion to be arranged inside the enclosure, the shield shell including a first part to be arranged inside the outer arrangement portion and a second part arranged at a position shifted from the first part in a direction opposite to the first direction, the first part including a first shield connecting portion to be electrically connected to the electromagnetic shield member, the first part covering an outer periphery of a part of the wire to be arranged inside the outer arrangement portion, the second part including a second shield connecting portion to be fixed and electrically connected to the enclosure inside the enclosure, and the second shield connecting portion being located inside an outer edge of the connector housing when viewed from the first direction.

According to this configuration, an electrically connected part of the shield shell and the enclosure can be arranged inside the enclosure. Further, the first part to be arranged inside the outer arrangement portion includes the first shield connecting portion to be electrically connected to the electromagnetic shield member. That is, an electrically connected part of the shield shell and the electromagnetic shield member is arranged inside the connector housing. From these, the electrically connected part of the shield shell and the enclosure and the electrically connected part of the shield shell and the electromagnetic shield member can be suppressed from being wetted. Therefore, it is possible to suppress a reduction in electromagnetic shielding performance due to water adhesion to the electrically connected part of the shield shell and the enclosure and the electrically connected part of the shield shell and the electromagnetic shield member.

Further, the second shield connecting portion is located inside the outer edge of the connector housing when viewed from the first direction. Thus, the second shield connecting portion is fixed to the enclosure at a position near the wire as compared to the case where the second shield connecting portion is located outside the outer edge of the connector housing when viewed from the first direction. Therefore, the vibration of the connector with respect to the enclosure is easily suppressed if the wire vibrates when the second shield connecting portion is fixed to the enclosure.
[2] In [1] described above, the second shield connecting portion includes a first through hole, a bolt for fixing the enclosure and the second shield connecting portion being passed through the first through hole.

According to this configuration, the second shield connecting portion can be easily fixed to the enclosure by the bolt and the nut to be attached to the bolt. Further, since the second shield connecting portion is integrated with the enclosure if the second shield connecting portion is fixed to the enclosure by the bolt and the nut, a relative movement of the second shield connecting portion with respect to the enclosure can be suppressed. Therefore, the vibration of the connector with respect to the enclosure can be more suppressed.
[3] In [2] described above, the terminal includes a second through hole, a terminal fixing bolt for fixing a mating terminal arranged inside the enclosure and the terminal being passed through the second through hole, the first through hole penetrates through the second shield connecting portion in a second direction orthogonal to the first direction, and the second through hole penetrates through the terminal in the second direction.

According to this configuration, the direction in which the terminal fixing bolt is passed through the terminal and the mating terminal to connect the terminal and the mating terminal and the direction in which the bolt for fixing the second shield connecting portion to the enclosure is passed through the enclosure and the second shield connecting portion can be the same. Therefore, the connection workability of the second shield connecting portion and the enclosure and that of the terminal and the mating terminal can be improved.
[4] In [2] or [3] described above, the shield shell includes a nut fixed in the first through hole and to be attached to the bolt.

According to this configuration, the second shield connecting portion can be easily fixed to the enclosure by inserting the bolt for fixing the second shield connecting portion to the enclosure into the nut fixed in the first through hole.
[5] The connector fixing structure of the present disclosure is provided with an electrically conductive enclosure of a device, a connector housing for holding a terminal and a wire electrically connected to the terminal and pulled out along a first direction, and an electrically conductive shield shell, the enclosure including a mounting opening, the terminal being inserted through the mounting opening, and a shield shell connecting portion provided inside the enclosure, the connector housing including an outer arrangement portion to be arranged outside the enclosure and an inner arrangement portion to be arranged inside the enclosure, the outer arrangement portion including a fixing portion to be fixed to an outer surface of the enclosure, the wire being a shielded wire including a core wire, a first insulation coating covering an outer periphery of the core wire, an electrically conductive electromagnetic shield member covering an outer periphery of the first insulation coating and a second insulation coating covering an outer periphery of the electromagnetic shield member, the shield shell including a first part to be arranged inside the outer arrangement portion and a second part to be arranged inside the enclosure together with the inner arrangement portion, the first part including a first shield connecting portion to be electrically connected to the electromagnetic shield member, the first part covering an outer periphery of a part of the wire to be arranged inside the outer arrangement portion, the second part including a second shield connecting portion, and the second shield connecting portion being located inside an outer edge of the connector when viewed from the first direction, the second shield connecting portion being fixed and electrically connected to the shield shell connecting portion inside the enclosure.

According to this configuration, functions and effects similar to those of [1] described above can be achieved.

### Details of Embodiment of Present Disclosure

Specific examples of a connector and connector fixing structure of the present disclosure are described below with reference to the drawings. For the convenience of description, some components may be shown in an exaggerated or simplified manner in each drawing. Further, a dimension ratio of each part may be different in each figure. In each figure, X, Y and Z axes orthogonal to each other are shown. “Orthogonal” in this specification means not only strictly orthogonal, but also substantially orthogonal within a range in which functions and effects in an embodiment are achieved. Further, a term “annular” used in this specification may indicate an arbitrary structure forming a loop, i.e. a continuous shape having no end part and a loop-shaped structure as a whole including a gap such as a C shape. “Annular” shapes include circular shapes, elliptical shapes and polygonal shapes with angular or round corners, but there is no limitation to these. Further, terms such as “first”, “second” and “third” in this specification are merely used to distinguish objects and do not rank the objects. Note that the present invention is not limited to these illustrations, but is represented by claims and intended to include all changes in the scope of claims and in the meaning and scope of equivalents.

Hereinafter, a connector and a connector fixing structure according to one embodiment are described.

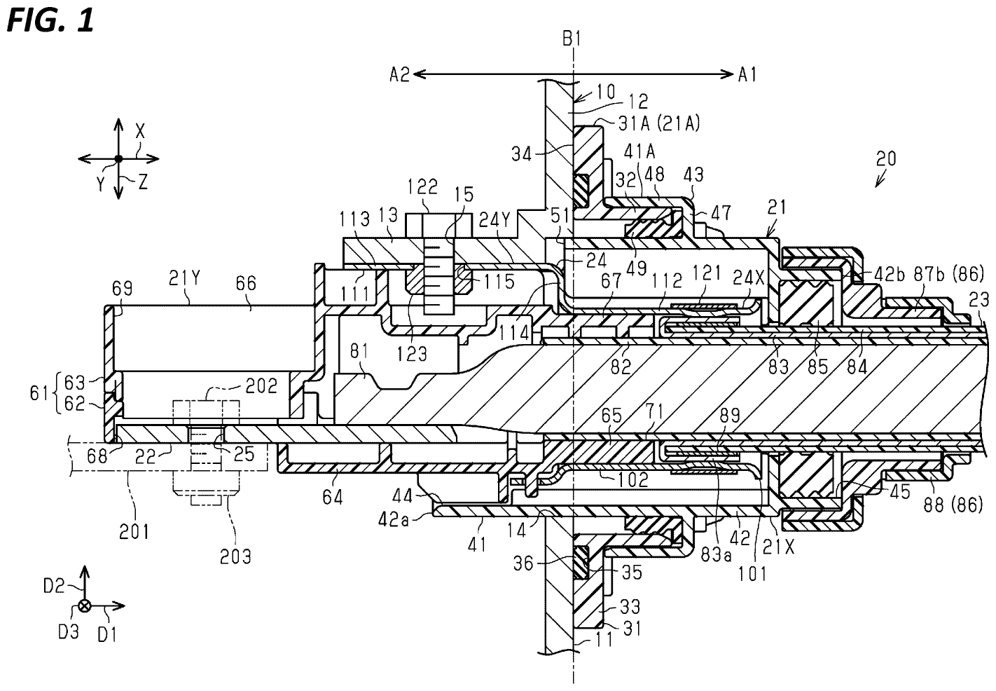

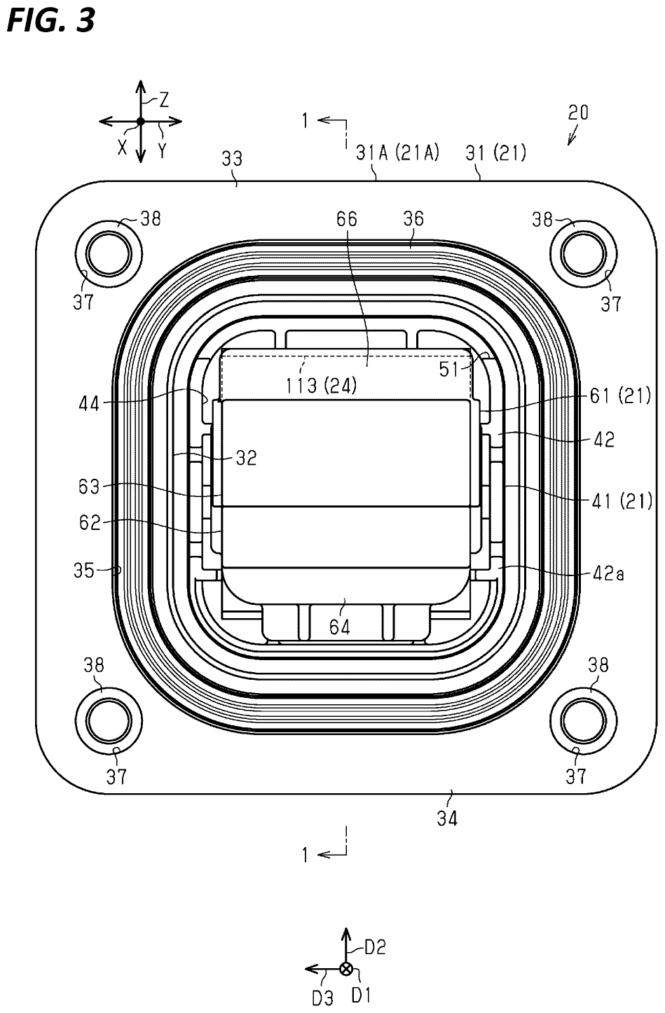

As shown in FIG. 1, a connector 20 is provided on an end part of a wiring harness. Note that FIG. 1 is a section along 1-1 in FIG. 3. The connector 20 is arranged in a vehicle. The vehicle includes, for example, a plurality of devices such as a high-voltage battery, an inverter and a wheel drive motor. The connector 20 is mounted on one device 10, out of the plurality of devices.

### Configuration of Enclosure 11

The device 10 is provided with an electrically conductive enclosure 11. For example, the enclosure 11 is made of metal such as aluminum or aluminum alloy. Note that the enclosure 11 is not limited to the one made of metal, but may be made of an electrically conductive resin material.

The enclosure 11 includes, for example, a box-shaped body portion 12 and a shield shell connecting portion 13 provided inside the body portion 12, i.e. inside the enclosure 11. The body portion 12 includes a mounting opening 14, through which a terminal 22 is inserted. The mounting opening 14 allows communication between the inside and the outside of the body portion 12. For example, the mounting opening 14 penetrates through a side wall of the body portion 12 along the X axis. The shield shell connecting portion 13 is electrically connected to the body portion 12. The body portion 12 and the shield shell connecting portion 13 are, for example, integrally formed. Note that the shield shell connecting portion 13 may be formed separately from the body portion 12. In this case, the shield shell connecting portion 13 is electrically connected to the body portion 12 by being fixed to the body portion 12. The shield shell connecting portion 13 includes, for example, a through hole 15. For example, the through hole 15 penetrates through the shield shell connecting portion 13 along the Y axis.

### Configuration of Connector 20

The connector 20 is provided with a connector housing 21 to be fixed to the enclosure 11, the terminal 22 to be held in the connector housing 21, a wire 23 and an electrically conductive shield shell 24.

### Configuration of Connector Housing 21

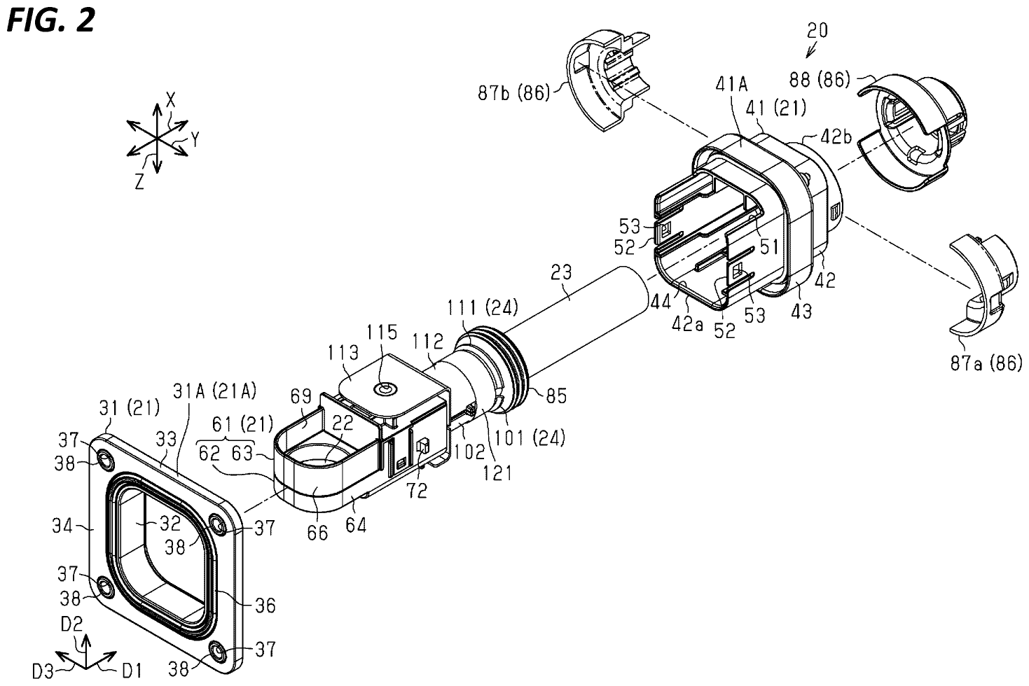

As shown in FIGS. 1 and 2, the connector housing 21 includes, for example, a first housing 31, a second housing 41 and a third housing 61.

The first housing 31 is, for example, made of synthetic resin. The first housing 31 includes, for example, a tubular portion 32 having a tubular shape extending along a first direction D1 and a fixing portion 33 integrally provided on the outer peripheral surface of the tubular portion 32. The first direction D1 is a direction from the inside toward the outside of the enclosure 11 through the mounting opening 14. The first direction D1 is, for example, one direction (direction of a rightward arrow shown in FIG. 1) along the X axis. Further, a direction orthogonal to the first direction DI is defined as a second direction D2. The second direction D2 is, for example, one direction along the Z axis. Further, a direction orthogonal to the first direction D1 and the second direction D2 is defined as a third direction D3. The third direction D3 is, for example, a direction along the Y axis. The first, second and third directions D1, D2 and D3 are directions in an assembled state of the connector 20 below unless otherwise stated.

The fixing portion 33 is, for example, in the form of a flange extending from an end region in a direction opposite to the first direction D1 in the tubular portion 32 toward the outside of the tubular portion 32. The fixing portion 33 has, for example, an annular shape surrounding the tubular portion 32. The fixing portion 33 has a facing surface 34 facing the outer surface of the enclosure 11. For example, the facing surface 34 is an end surface in the direction opposite to the first direction D1, out of both end surfaces of the fixing portion 33 in the first direction D1. For example, the facing surface 34 is a flat surface perpendicular to the first direction D1.

As shown in FIGS. 1 and 3, the fixing portion 33 may include a sealing groove 35 recessed in the first direction D1 from the facing surface 34. The sealing groove 35 has an annular shape surrounding the tubular portion 32 when viewed from the first direction D1. The connector 20 may include a first sealing member 36 to be arranged in the sealing groove 35. The first sealing member 36 is, for example, a rubber ring.

The fixing portion 33 includes, for example, four fixing holes 37. Note that the number of the fixing holes 37 of the fixing portion 33 is not limited to four, but may be any plural number. Each fixing hole 37 penetrates through the fixing portion 33 in the first direction D1. Each fixing hole 37 is located outside the sealing groove 35 when viewed from the first direction D1. Further, a plurality of the fixing holes 37 are, for example, separated by an equal distance along an outer edge 31A of the fixing portion 33 when viewed from the first direction D1. An annular collar 38 made of metal may be mounted on the inner peripheral surface of each fixing hole 37.

The first housing 31 is fixed to an outer peripheral part of the mounting opening 14 in the body portion 12 of the enclosure 11. The first housing 31 is so arranged on the enclosure 11 that the mounting opening 14 is arranged inside the tubular portion 32 when viewed from the first direction D1. Further, the first housing 31 is arranged on the enclosure 11 with the facing surface 34 facing the outer surface of the body portion 12. The first housing 31 is fixed to the body portion 12 by unillustrated screws inserted through the respective fixing holes 37. Note that the first sealing member 36 seals between the outer surface of the enclosure 11 and the fixing portion 33 by being held in close contact with the inner surface of the sealing groove 35 and the outer surface of the enclosure 11. That is, the first sealing member 36 suppresses water intrusion into the inside of the enclosure 11 or the inside of the connector 20 through a gap between the outer surface of the enclosure 11 and the fixing portion 33.

As shown in FIGS. 1 and 2, the second housing 41 includes, for example, a tubular second housing body 42 extending along the first direction D1 and an outer fitting portion 43 integrally provided on the outer peripheral surface of the second housing body 42. The second housing 41 is, for example, made of synthetic resin.

The second housing body 42 has a first end 42a and a second end 42b on a side opposite to the first end 42a in the first direction D1. The second housing 41 may include a projection opening 44, through which the terminal 22 projects along the direction opposite to the first direction D1. The projection opening 44 is located on the first end 42a of the second housing body 42. Further, the second housing 41 includes a through opening 45, through which the wire 23 is passed in the first direction D1. The through opening 45 is located on the second end 42b of the second housing body 44.

The second housing body 42 is inserted and arranged inside the tubular portion 32. Further, the second housing body 42 is, for example, inserted into the enclosure 11 through the mounting opening 14. For example, the second housing body 42 is arranged such that the first end 42a is arranged inside the enclosure 11, whereas the second end 42b is arranged outside the enclosure 11.

The second housing body 42 includes, for example, an exposure recess 51 in an end region including the first end 42a in the second housing body 42. The exposure recess 51 is located in an end part of the second housing body 42 in the second direction D2. The exposure recess 51 is recessed in the first direction D1 from the first end 42a. The inside of the second housing body 42 is exposed to the outside of the second housing body 42 through the exposure recess 51. The exposure recess 51 is arranged inside the enclosure 11.

As shown in FIG. 1, the outer fitting portion 43 includes a bottom wall 47 in the form of a flange extending from the outer peripheral surface of the second housing body 42 and an annular fitting portion 48 extending in the direction opposite to the first direction D1 from the outer edge of the bottom wall 47. The tubular portion 32 is fit inside the fitting portion 48.

A second sealing member 49 is arranged between the outer peripheral surface of the second housing body 42 and the inner peripheral surface of the tubular portion 32. The second sealing member 49 is arranged inside the outer fitting portion 43. The second sealing member 49 is, for example, a rubber ring. The second sealing member 49 seals between the inner peripheral surface of the tubular portion 32 and the outer peripheral surface of the second housing body 42. That is, the second sealing member 49 suppresses water intrusion into the inside of the enclosure 11 or the inside of the connector 20 through a gap between the outer peripheral surface of the second housing body 42 and the inner peripheral surface of the tubular portion 32.

As shown in FIG. 2, the second housing body 42 may include first engaging portions 52. For example, one first engaging portion 52 is provided in each of both side surfaces of the second housing body 42. Each first engaging portion 52 is, for example, a part between a pair of grooves provided in a tip region of the second housing body 42 including the first end 42a. Each first engaging portion 52 is so resiliently deformable that the tip thereof is shifted along the third direction D3 with respect to the base end thereof.

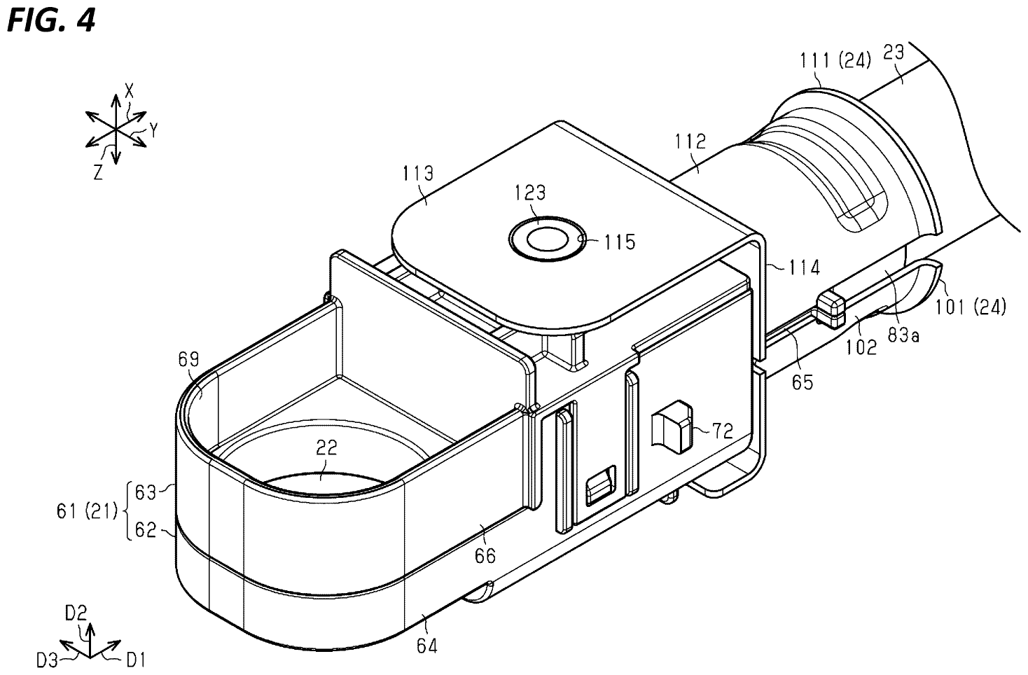

As shown in FIGS. 1 and 4, the third housing 61 includes, for example, a first divided housing 62 and a second divided housing 63 to be assembled with the first divided housing 62. Each of the first and second divided housings 62, 63 is, for example, made of resin. The second divided housing 63 is overlaid on the first divided housing 62 at a position shifted from the first divided housing 62 in the second direction D2. Further, the second divided housing 63 is fixed to the first divided housing 62.

The first divided housing 62 includes, for example, a first terminal holding portion 64 and a first wire holding portion 65. The second divided housing 63 includes, for example, a second terminal holding portion 66 and a second wire holding portion 67. The second terminal holding portion 66 is overlaid on the first terminal holding portion 64 at a position shifted from the first terminal holding portion 64 in the second direction D2. The third housing 61 holds the terminal 22 between the first and second terminal holding portions 64, 66.

The first terminal holding portion 64 includes, for example, a first terminal exposure opening 68. The second divided housing 63 includes, for example, a second terminal exposure opening 69. The first and second terminal exposure openings 68, 69 are juxtaposed in the second direction D2. A part of the terminal 22 is arranged between the first and second terminal exposure openings 68, 69. Both end surfaces in the second direction D2 of the part of the terminal 22 located between the first and second terminal exposure openings 68, 69 are exposed to the outside of the connector 20 through the first and second terminal exposure openings 68, 69.

The first wire holding portion 65 extends, for example, in the first direction D1 from an end part in the first direction D1 of the first terminal holding portion 64. The second wire holding portion 67 extends, for example, in the first direction D1 from an end part in the first direction D1 of the second terminal holding portion 66. The third housing 61 holds an end region of the wire 23 in the direction opposite to the first direction D1 between the first and second wire holding portion 65, 67. The first and second wire holding portions 65, 67 are, for example, overlapped to sandwich the wire 23 from both sides in the second direction D2. The first and second wire holding portions 65, 67 overlapped each other form a hollow cylindrical shape extending in the first direction D1.

As shown in FIG. 1, the third housing 61 includes a wire through opening 71, through which the wire 23 is passed in the first direction D1. For example, the wire through opening 71 is located in an end part of the third housing 61 in the first direction D1, i.e. end parts of the first and second wire holding portions 65, 67 in the first direction D1. The third housing 61 is so inserted into the second housing body 42 along the first direction D1 that the wire through opening 71 is arranged inside the second housing body 42. The first and second terminal holding portions 64, 66 project outwardly of the second housing body 42 in the direction opposite to the first direction D1 from the projection opening 44.

As shown in FIG. 2, the third housing 61 may include second engaging portions 72 to be fit to the first engaging portions 52 of the second housing 41. For example, the third housing 61 includes the second engaging portions 72 on both ends of the first divided housing 62 in the third direction D3. The second engaging portion 72 is a protrusion projecting in a Y-axis direction from the outer surface of the first divided housing 62. The third housing 61 is inserted into the second housing 41 along the first direction D1. The second engaging portions 72 are fit into engaging holes 53 of the first engaging portions 52 on both sides of the third housing 61 in the third direction D3, whereby the second housing 41 and the third housing 61 are fixed.

### Configuration of Terminal 22

As shown in FIG. 1, the terminal 22 is in the form of a flat plate orthogonal to the second direction D2. The terminal 22 is, for example, made of a metal material such as copper, copper alloy, aluminum or aluminum alloy. The wire 23 is electrically connected to the terminal 22. The terminal 22 and the wire 23 are, for example, joined by crimping, welding such as ultrasonic welding or laser welding, or another known joining method. The third housing 61 accommodates an electrically connected part of the wire 23 and the terminal 22 between the first and second divided housings 62, 63.

The terminal 22 may include a second through hole 25, through which a terminal fixing bolt 202 for fixing a mating terminal 201 arranged inside the enclosure 11 and the terminal 22 is passed. For example, the second through hole 25 penetrates through the terminal 22 in the second direction D2. The second through hole 25 is exposed to the outside of the connector 20 through the first and second terminal exposure openings 68, 69.

### Configuration of Wire 23

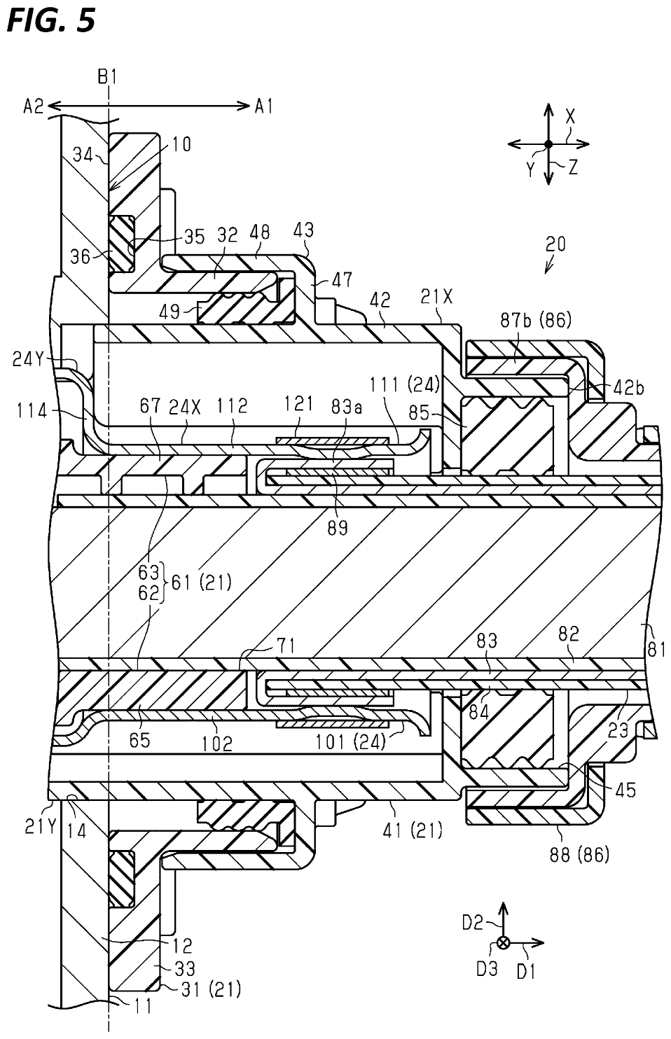

As shown in FIG. 5, the wire 23 is a shielded wire having an electromagnetic shielding structure. Note that FIG. 5 is a partial enlarged view of FIG. 1. The wire 23 includes a core wire 81 constituted by a conductor, a first insulation coating 82 covering the outer periphery of the core wire 81, an electromagnetic shield member 83 covering the outer periphery of the first insulation coating 82 and a second insulation coating 84 covering the outer periphery of the electromagnetic shield member 83. The wire 23 is, for example, a high-voltage wire compatible with high voltages and large currents. For example, a copper-based or aluminum-based metal material can be used as a material of the core wire 81. Each of the first and second insulation coatings 82, 84 is, for example, made of an insulating material such as synthetic resin. The electromagnetic shield member 83 is, for example, a braided wire formed by braiding electrically conductive strands of copper alloy, aluminum alloy or the like into a tubular shape.

The wire 23 extends in the first direction D1. The wire 23 is pulled out to outside from the inside of the connector housing 21 along the first direction D1. That is, the first direction D1 is a direction in which the wire 23 is pulled out to outside from the inside of the connector housing 21. The wire 23 comes out from the third housing 61 through the wire through opening 71 and comes out from the second housing 41, i.e. from the connector housing 21 through the through hole 45.

The connector 20 may include a third sealing member 85 for sealing between the inner peripheral surface of the second housing body 42 and the outer peripheral surface of the wire 23. The third sealing member 85 is arranged between the inner peripheral surface of an end region including the second end 42b in the second housing body 42 and the outer peripheral surface of the wire 23. The third sealing member 85 is located at a position shifted from the third housing 61 in the first direction D1. The third sealing member 85 is, for example, a rubber ring. The third sealing member 85 suppresses water intrusion into the inside of the connector 20 through the through opening 45.

As shown in FIGS. 1 and 2, the connector 20 includes a back retainer 86 to be mounted on an end region including the second end 42b in the second housing body 42. The back retainer 86 prevents the detachment of the third sealing member 85 from the second housing 41. The back retainer 86 includes, for example, divided retainers 87a, 87b divided into two in the third direction D3 and a fixing member 88 for fixing the divided retainers 87a, 87b to the second housing 41. The fixing member 88 has, for example, an annular shape. The fixing member 88 is externally fit to the divided retainers 87a, 87b. Note that the wire 23 is passed through the back retainer 86 in the first direction D1.

As shown in FIG. 5, the first insulation coating 82 of a part of the wire 23 inside the third housing 61 is exposed. For example, the second insulation coating 84 is removed over a range from an end of the wire 23 in the direction opposite to the first direction D1 to a position near the wire through opening 71 outside the third housing 61. Further, a first fixing member 89 is fixed to the wire 23. The first fixing member 89 is, for example, located between the wire through opening 71 and the through hole 45 in the first direction D1 inside the second housing body 42. In particular, the first fixing member 89 is located between the wire through opening 71 and the third sealing member 85. The first fixing member 89 is mounted on the outer periphery of an end region of the second insulation coating 84 in the direction opposite to the first direction D1. The first fixing member 89 is, for example, a crimp ring made of metal.

For example, the electromagnetic shield member 83 includes a folded portion 83a folded in the first direction D1 in an end region in the direction opposite to the first direction D1. The folded portion 83a is overlaid on the end region of the second insulation coating 84 in the direction opposite to the first direction D1 to cover the outer peripheral surface of the first fixing member 89.

### Configuration of Shield Sell 24

As shown in FIGS. 1 and 4, the shield shell 24 includes, for example, a first covering portion 101 and a second covering portion 111. The first and second covering portions 101, 111 are arranged on both sides of the third housing 61 in the second direction D2. Each of the first and second covering portions 101, 111 is, for example, formed by press-working a metal plate.

As shown in FIGS. 4 and 5, the first covering portion 101 includes, for example, a first connecting portion 102 in an end region in the first direction D1. The second covering portion 111 includes, for example, a second connecting portion 112 in an end region in the first direction D1. Note that, for example, the first and second connecting portions 102, 112 correspond to a “first shield connecting portion”. Each of the first and second connecting portions 102, 112 has, for example, a semicircular shape when viewed from the first direction D1. The first connecting portion 102 covers the outer peripheral surface of the first wire holding portion 65. The second connecting portion 112 covers the outer peripheral surface of the second wire holding portion 67. Further, the first and second connecting portions 102, 112 cover the outer peripheral surface of the folded portion 83a. The inner surface of each of the first and second connecting portions 102, 112 is in contact with the outer peripheral surface of the folded portion 83a. The first and second connecting portions 102, 112 also cover the outer periphery of a part of the wire 23 arranged outside the enclosure 11 and not covered by the electromagnetic shield member 83 when the connector 20 is fixed to the enclosure 11. The first and second connecting portions 102, 112 are arranged inside the second housing body 42.

The first and second covering portions 101, 111 are fixed to the wire 23 by a second fixing member 121. The second fixing member 121 is located between the wire through opening 71 and the through opening 45 in the first direction D1 inside the second housing body 42. In particular, the second fixing member 121 is located between the wire through opening 71 and the third sealing member 85. The second fixing member 121 is mounted at a position on the outer peripheries of the first and second connecting portions 102, 112 to sandwich the first connecting portion 102, the second connecting portion 112 and the folded portion 83a between the first fixing member 89 and the second fixing member 12. The second fixing member 121 is, for example, a crimp ring made of metal. The second fixing member 121 tightens each of the first and second connecting portions 102, 112 and the wire 23 such that the folded portion 83a is held in close contact with each of the first and second connecting portions 102, 112. In this way, the electromagnetic shield member 83 and each of the first and second covering portions 101, 111 are electrically connected.

As shown in FIGS. 1 and 4, the second covering portion 111 includes, for example, a second shield connecting portion 113 at a position shifted from the second connecting portion 112 in the direction opposite to the first direction D1. For example, the second shield connecting portion 113 is coupled to the second connecting portion 112 by a coupling/covering portion 114 extending in the second direction D2 from an end part of the second connecting portion 112 in the direction opposite to the first direction D1. The coupling/covering portion 114 covers an end surface in the first direction D1 of the second terminal holding portion 66. The second shield connecting portion 113 is, for example, in the form of a flat plate orthogonal to the second direction D2. When viewed from the direction opposite to the second direction D2, the second shield connecting portion 113 covers, for example, a part of the third housing 61 between the second terminal exposure opening 69 and the second wire holding portion 67.

As shown in FIG. 1, an end region of the second shield connecting portion 113 in the direction opposite to the first direction D1 projects from the second housing 41 in the direction opposite to the first direction D1. An end region of the second shield connecting portion 113 in the first direction D1 is at a position overlapping the exposure recess 51 of the second housing 41 in the second direction D2. Thus, an end surface of the second shield connecting portion 113 in the second direction D2 is entirely exposed to the outside of the connector housing 21.

As shown in FIG. 3, in the connector 20, the second shield connecting portion 113 is located inside an outer edge 21A of the connector housing 21 when viewed from the first direction D1. For example, the second shield connecting portion 113 is located inside an outer edge 31A of the fixing portion 33 of the first housing 31 when viewed from the first direction D1. Further, the second shield connecting portion 113 is, for example, located inside an outer edge 41A of the second housing 41 when viewed from the first direction D1. Note that the outer edge 41A is shown in FIGS. 1 and 2.

As shown in FIGS. 1 and 4, the second shield connecting portion 113 includes a first through hole 115, through which a bolt 122 for fixing the shield shell connecting portion 13 of the enclosure 11 and the second shield connecting portion 113 is passed. For example, the first through hole 115 penetrates through the second shield connecting portion 113 in the second direction D2. For example, the first through hole 115 is at a position shifted from the second through hole 25 in the first direction D1. Further, the first through hole 115 is, for example, arranged side by side with the second through hole 25 in the first direction D1 when viewed from the second direction D2.

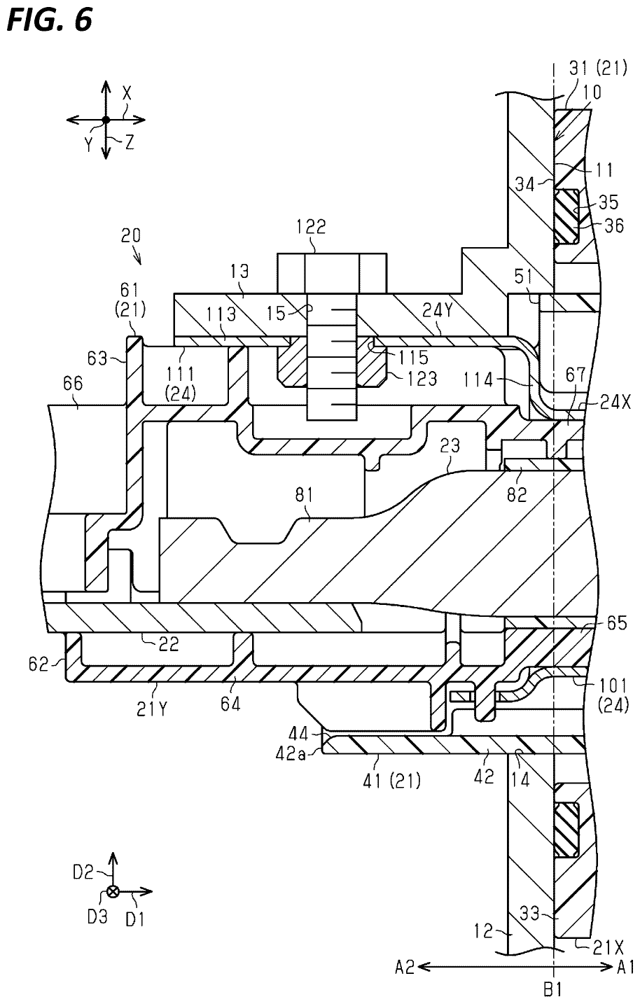

As shown in FIG. 6, the shield shell 24 includes a nut 123 fixed in the first through hole 115 and to be attached to the bolt 122. The nut 123 is, for example, located between the second shield connecting portion 113 and the second terminal holding portion 66 in the second direction D2. For example, the nut 123 is fixed in the first through hole 115 by being press-fit into the first through hole 115.

Next, a procedure of fixing the connector 20 to the enclosure 11 is described.

As shown in FIG. 1, the first housing 31 is first fixed to the outer peripheral part of the mounting opening 14 in the body portion 12 of the enclosure 11. Thereafter, the second and third housings 41, 61 fixed to each other are mounted into the first housing 31. Note that components such as the wire 23 and the terminal 22 other than the first housing 31, the first sealing members 36 and the collars in the connector 20 are mounted in the second and third housings 41, 61 in advance. When the second and third housings 41, 61 are mounted into the first housing 31, the first terminal holding portion 64, the second terminal holding portion 66, the terminal 22 and the second shield connecting portion 113 are inserted into the enclosure 11 through the tubular portion 32 and the mounting opening 14. Then, the second shield connecting portion 113 is arranged at a position overlapping the shield shell connecting portion 13 in the second direction D2 inside the enclosure 11.

Thereafter, the bolt 122 is inserted into the through hole 15 and the first through hole 115 in the direction opposite to the second direction D2 and tightened into the nut 123. At this time, a tool for tightening the bolt 122 and the nut 123 is, for example, inserted into the enclosure 11 through an opening provided at a position different from the mounting opening 14 in the enclosure 11. By tightening the nut 123 and the bolt 122, the second shield connecting portion 113 is fixed and electrically connected to the shield shell connecting portion 13 inside the enclosure 11. When the second shield connecting portion 113 is fixed to the shield shell connecting portion 13, the fixing of the connector 20 to the enclosure 11 is completed.

Note that the terminal 22 and the mating terminal 201 may be connected before the second shield connecting portion 113 and the shield shell connecting portion 13 are connected, or may be connected after the second shield connecting portion 113 and the shield shell connecting portion 13 are connected. The terminal 22 and the mating terminal 201 are fixed and electrically connected to each other by the terminal fixing bolt 202 passed through the second through hole 25 and the mating terminal 201 and the nut 203 to be attached to the terminal fixing bolt 202. For example, the terminal fixing bolt 202 is inserted into the second through hole 25 in the direction opposite to the second direction D2, similarly to the bolt 122. Note that the terminal fixing bolt 202 may be passed through the mating terminal 201 and the terminal 22 in the second direction D2. Further, a tool for tightening the terminal fixing bolt 202 and the nut 203 is, for example, inserted into the enclosure 11 through an opening provided at a position different from the mounting opening 14 in the enclosure 11, similarly to the tool for tightening the bolt 122 and the nut 123.

A boundary B1 between an outer region Al outside the enclosure 11 and an inner region A2 inside the enclosure 11 is shown by a one-dot chain line in FIG. 1. For example, the boundary B1 is located on the outer surface of the enclosure 11. The connector housing 21 includes an outer arrangement portion 21X to be arranged outside the enclosure 11 and an inner arrangement portion 21Y to be arranged inside the enclosure 11. That is, the connector housing 21 includes the outer arrangement portion 21X to be arranged in the outer region A1 and the inner arrangement portion 21Y to be arranged in the inner region A2. In FIG. 1, the outer arrangement portion 21X is a part arranged in a range of the connector housing 21 shifted from the boundary B1 in the first direction D1. The inner arrangement portion 21Y is a part arranged in a range of the connector housing 21 shifted from the boundary B1 in the direction opposite to the first direction D1.

For example, the first housing 31 is included in the outer arrangement portion 21X. Thus, the outer arrangement portion 21X includes the fixing portion 33 to be fixed to the outer surface of the enclosure 11.

Further, the shield shell 24 includes a first part 24X to be arranged inside the outer arrangement portion 21X and a second part 24Y arranged at a position shifted from the first part 24X in the direction opposite to the first direction D1. The first part 24X is a part to be arranged in the outer region A1 in the shield shell 24. The second part 24Y is a part to be arranged in the inner region A2 in the shield shell 24. The first part 24X includes the first and second connecting portions 102, 112 to be electrically connected to the electromagnetic shield member 83 and covers the outer periphery of a part of the wire 23 to be arranged inside the outer arrangement portion 21X. Further, the second part 24Y includes the second shield connecting portion 113 to be fixed and electrically connected to the enclosure 11 inside the enclosure 11.

Functions and effects of this embodiment are described.
(1) The connector 20 is provided with the connector housing 21 to be fixed to the electrically conductive enclosure 11 of the device 10 and the terminal 22 to be held in the connector housing 21. Further, the connector 20 is provided with the wire 23 to be electrically connected to the terminal 22 and pulled out to outside from the inside of the connector housing 21 along the first direction D1, and the electrically conductive shield shell 24. The wire 23 is the shielded wire including the core wire 81, the first insulation coating 82 covering the outer periphery of the core wire 81, the electrically conductive electromagnetic shield member 83 covering the outer periphery of the first insulation coating 82 and the second insulation coating 84 overing the outer periphery of the electromagnetic shield member 83. The connector housing 21 includes the outer arrangement portion 21X to be arranged outside the enclosure 11 and the inner arrangement portion 21Y to be arranged inside the enclosure 11. The shield shell 24 includes the first part 24X to be arranged inside the outer arrangement portion 21X and the second part 24Y to be arranged at the position shifted from the first part 24X in the direction opposite to the first direction D1. The first part 24X includes the first and second connecting portions 102, 112 to be electrically connected to the electromagnetic shield member 83 and covers the outer periphery of the part of the wire 23 to be arranged inside the outer arrangement portion 21X. The second part 24Y includes the second shield connecting portion 113 to be fixed and electrically connected to the enclosure 11 inside the enclosure 11. The second shield connecting portion 113 is located inside the outer edge 21A of the connector housing 21 when viewed from the first direction D1.

According to this configuration, the electrically connected part of the shield shell 24 and the enclosure 11 can be arranged inside the enclosure 11. In this embodiment, the electrically connected part of the shield shell 24 and the enclosure 11 is a part in contact with the shield shell connecting portion 13 and the second shield connecting portion 113. Further, the first part 24X to be arranged inside the outer arrangement portion 21X includes the first and second connecting portions 102, 112 to be electrically connected to the electromagnetic shield member 83. That is, an electrically connected part of the shield shell 24 and the electromagnetic shield member 83 is arranged inside the connector housing 21. In this embodiment, the electrically connected part of the shield shell 24 and the electromagnetic shield member 83 is a part where each of the first and second connecting portions 102, 112 and the electromagnetic shield member 83 are in contact. From these, the electrically connected part of the shield shell 24 and the enclosure 11 and the electrically connected part of the shield shell 24 and the electromagnetic shield member 83 can be suppressed from being wetted. Therefore, it is possible to suppress a reduction in electromagnetic shielding performance due to water adhesion to the electrically connected part of the shield shell 24 and the enclosure 11 and the electrically connected part of the shield shell 24 and the electromagnetic shield member 83.

Further, the second shield connecting portion 113 is located inside the outer edge 21A of the connector housing 21 when viewed from the first direction D1. Thus, the second shield connecting portion 113 is fixed to the enclosure 11 at a position near the wire 23 as compared to the case where the second shield connecting portion 113 is located outside the outer edge 21A of the connector housing 21 when viewed from the first direction D1. Therefore, the vibration of the connector 20 with respect to the enclosure 11 is easily suppressed if the wire 23 vibrates when the second shield connecting portion 113 is fixed to the enclosure 11.

Further, if the wire 23 is a high-voltage wire compatible with high voltages and large currents, a diameter of the wire 23 generally increases. If the diameter of the wire 23 increases, the connector 20 is easily affected by the vibration of the wire 23 when the wire 23 vibrates. In the connector 20 of this embodiment, even if such a wire 23 is provided, the vibration of the connector 20 due to the vibration of the wire 23 is easily suppressed since the second shield connecting portion 113 is located inside the outer edge 21A of the connector housing 21 when viewed from the first direction D1.
(2) The second shield connecting portion 113 includes the first through hole 115, through which the bolt 122 for fixing the enclosure 11 and the second shield connecting portion 113 is passed. According to this configuration, the second shield connecting portion 113 can be easily fixed to the enclosure 11 by the bolt 122 and the nut 123 to be attached to the bolt 122. Further, since the second shield connecting portion 113 is integrated with the enclosure 11 if the second shield connecting portion 113 is fixed to the enclosure 11 by the bolt 122 and the nut 123, a relative movement of the second shield connecting portion 113 with respect to the enclosure 11 can be suppressed. Therefore, the vibration of the connector 20 with respect to the enclosure 11 can be more suppressed.
(3) The terminal 22 includes the second through hole 25, through which the terminal fixing bolt 202 for fixing the mating terminal 201 arranged inside the enclosure 11 and the terminal 22 is passed. The first through hole 115 penetrates through the second shield connecting portion 113 in the second direction D2 orthogonal to the first direction D1. The second through hole 25 penetrates through the terminal 22 in the second direction D2.

According to this configuration, the direction in which the terminal fixing bolt 202 is passed through the terminal 22 and the mating terminal 201 to connect the terminal 22 and the mating terminal 201 and the direction in which the bolt 122 for fixing the second shield connecting portion 113 to the enclosure 11 is passed through the enclosure 11 and the second shield connecting portion 113 can be the same. Therefore, the connection workability of the second shield connecting portion 113 and the enclosure 11 and that of the terminal 22 and the mating terminal 201 can be improved.
(4) The shield shell 24 includes the nut 123 fixed in the first through hole 115 and to be attached to the bolt 122. According to this configuration, the second shield connecting portion 113 can be easily fixed to the enclosure 11 by inserting the bolt 122 for fixing the second shield connecting portion 113 to the enclosure 11 into the nut 123 fixed in the first through hole 115.
(5) The fixing structure of the connector 20 is provided with the electrically conductive enclosure 11 of the device 10. Further, the fixing structure of the connector 20 is provided with the connector housing 21 for holding the terminal 22 and the wire 23 electrically connected to the terminal 22 and the pulled out along the first direction D1, and the electrically conductive shield shell 24. The enclosure 11 includes the mounting opening 14, through which the terminal 22 is inserted, and the shield shell connecting portion 13 provided inside the enclosure 11. The connector housing 21 includes the outer arrangement portion 21X to be arranged outside the enclosure 11 and the inner arrangement portion 21Y to be arranged inside the enclosure 11. The outer arrangement portion 21X includes the fixing portion 33 to be fixed to the outer surface of the enclosure 11. The wire 23 is the shielded wire including the core wire 81, the first insulation coating 82 covering the outer periphery of the core wire 81, the electrically conductive electromagnetic shield member 83 covering the outer periphery of the first insulation coating 82 and the second insulation coating 84 covering the outer periphery of the electromagnetic shield member 83. The shield shell 24 includes the first part 24X to be arranged inside the outer arrangement portion 21X and the second part 24Y to be arranged inside the enclosure 11 together with the inner arrangement portion 21Y. The first part 24X includes the first and second connecting portions 102, 112 to be electrically connected to the electromagnetic shield member 83 and covers the outer periphery of the part of the wire 23 to be arranged inside the outer arrangement portion 21X. The second part 24Y includes the second shield connecting portion 113. The second shield connecting portion 113 is located inside the outer edge 21A of the connector housing 21 when viewed from the first direction D1, and fixed and electrically connected to the shield shell connecting portion 13 inside the enclosure 11. According to this configuration, functions and effects similar to those of (1) described above can be achieved.
(6) To suppress an electrically connected part of a shield shell and an enclosure and an electrically connected part of the shield shell and an electromagnetic shield member from being wetted, it is thought to provide a connector with a cover for entirely covering the outer surface of a connector housing fixed to the enclosure. However, in this case, the connector is enlarged. In contrast, in this embodiment, the electrically connected part of the shield shell 24 and the enclosure 11 is arranged inside the enclosure 11 and the electrically connected part of the shield shell 24 and the electromagnetic shield member 83 is arranged inside the connector housing 21. Therefore, as compared to the case where the connector is provided with the cover, the electrically connected part of the shield shell 24 and the enclosure 11 and the electrically connected part of the shield shell 24 and the electromagnetic shield member 83 can be suppressed from being wetted while the enlargement of the connector 20 is suppressed. Further, since the connector 20 needs not be provided with a cover as a component, an increase in the number of components can be suppressed.

This embodiment can be modified and carried out as follows. This embodiment and the following modifications can be carried out in combination without technically contradicting each other.
The nut 123 may not be fixed in the first through hole 115 by being press-fit. For example, the nut 123 may be, for example, fixed to the shield shell 24 by adhesion or welding. Further, the nut 123 may be held by the connector housing 21. Further, the nut 123 may be prepared separately from the shield shell 24 and the connector housing 21. In this case, when the connector 20 is fixed to the enclosure 11, the nut 123 is attached to the bolt 122 passed through the shield shell connecting portion 13 and the second shield connecting portion 113.
In the above embodiment, the connector 20 is provided with the nut 123 for fixing the shield shell connecting portion 13 and the second shield connecting portion 113. However, the connector 20 may be provided with the bolt 122 for fixing the shield shell connecting portion 13 and the second shield connecting portion 113.
The second through hole 25 may penetrate through the terminal 22 in a direction different from the second direction D2. Further, the first through hole 115 may penetrate through the second shield connecting portion 113 in a direction different from the second direction D2. Further, the first and second through holes 115, 25 may penetrate in mutual different directions.
The second shield connecting portion 113 and the shield shell connecting portion 13 may be fixed by a method other than bolt fastening using the bolt 122 and the nut 123. For example, the second shield connecting portion 113 and the shield shell connecting portion 13 may be fixed by a clip for sandwiching the second shield connecting portion 113 and the shield shell connecting portion 13. Further, for example, the shield shell connecting portion 13 may have a clip shape to sandwich the second shield connecting portion 113 or a female terminal shape, into which the second shield connecting portion 113 is fit. Further, for example, the second shield connecting portion 113 and the shield shell connecting portion 13 may be fixed by welding or crimping. In these cases, the second shield connecting portion 113 may not include the first through hole 115. Further, the shield shell connecting portion 13 may not include the through hole 15. The method for fixing the terminal 22 and the mating terminal 201 may also be similarly changed.
The shape and configuration of the connector housing 21 are not limited to those of the above embodiment if the connector housing 21 includes the outer arrangement portion 21X to be arranged outside the enclosure 11 and the inner arrangement portion 21Y to be arranged inside the enclosure 11. For example, the first and second housings 31, 41 may constitute an integrally molded product.
The shape and configuration of the shield shell 24 are not limited to those of the above embodiment if the shield shell 24 includes the first part 24X to be arranged inside the outer arrangement portion 21X and the second part 24Y arranged at the position shifted from the first part 24X in the direction opposite to the first direction D1. For example, the first and second covering portions 101, 111 may be integrally formed. Further, for example, the shield shell 24 may be composed of a plurality of components divided into a plurality of pieces in the first direction D1.
The number of the terminal 22 provided in the connector 20 is not limited to one and a plurality of terminals 22 may be provided. In this case, the plurality of terminals 22 are arranged side by side along a direction orthogonal to the first direction D1. One wire 23 is electrically connected to each of the terminals 22.
The direction opposite to the second direction D2 in the above embodiment may be defined as the second direction D2. The direction opposite to the third direction D3 in the above embodiment may be defined as the third direction D3.
The embodiment disclosed this time should be considered illustrative in all aspects, rather than restrictive. The scope of the present invention is represented not by the above meaning, but by claims, and intended to include all changes in the scope of claims and in the meaning and scope of equivalents.

### List of Reference Numerals

10 device
11 enclosure
12 body portion
13 shield shell connecting portion
14 mounting opening
15 through hole
20 connector
21 connector housing
21A outer edge
21X outer arrangement portion
21Y inner arrangement portion
22 terminal
23 wire
24 shield shell
24X first part
24Y second part
25 second through hole
31 first housing
31A outer edge
32 tubular portion
33 fixing portion
34 facing surface
35 sealing groove
36 first sealing member
37 fixing hole
38 collar
41 second housing
41A outer edge
42 second housing body
42a first end
42b second end
43 outer fitting portion
44 projection opening
45 through opening
47 bottom wall
48 fitting portion
49 second sealing member
51 exposure recess
52 first engaging portion
53 engaging hole
61 third housing
62 first divided housing
63 second divided housing
64 first terminal holding portion
65 first wire holding portion
66 second terminal holding portion
67 second wire holding portion
68 first terminal exposure opening
69 second terminal exposure opening
71 wire through opening
72 second engaging portion
81 core wire
82 first insulation coating
83 electromagnetic shield member
83a folded portion
84 second insulation coating
85 third sealing member
86 back retainer
87a, 87b divided retainer
88 fixing member
89 first fixing member
101 first covering portion
102 first connecting portion (first shield connecting portion)
111 second covering portion
112 second connecting portion (first shield connecting portion)
113 second shield connecting portion
114 coupling/covering portion
115 first through hole
122 bolt
123 nut
121 second fixing member
201 mating terminal
202 terminal fixing bolt
203 nut
A1 outer region
A2 inner region
B1 boundary
D1 first direction
D2 second direction
D3 third direction

1. A connector, comprising:
a connector housing to be fixed to an electrically conductive enclosure of a device;
a terminal to be held in the connector housing;
a wire to be electrically connected to the wire and pulled out to outside from inside of the connector housing along a first direction; and
an electrically conductive shield shell,
the wire being a shielded wire including a core wire, a first insulation coating covering an outer periphery of the core wire, an electrically conductive electromagnetic shield member covering an outer periphery of the first insulation coating and a second insulation coating covering an outer periphery of the electromagnetic shield member,
the connector housing including an outer arrangement portion to be arranged outside the enclosure and an inner arrangement portion to be arranged inside the enclosure,
the shield shell including a first part to be arranged inside the outer arrangement portion and a second part arranged at a position shifted from the first part in a direction opposite to the first direction,
the first part including a first shield connecting portion to be electrically connected to the electromagnetic shield member, the first part covering an outer periphery of a part of the wire to be arranged inside the outer arrangement portion,
the second part including a second shield connecting portion to be fixed and electrically connected to the enclosure inside the enclosure, and
the second shield connecting portion being located inside an outer edge of the connector housing when viewed from the first direction.

2. The connector of claim 1, wherein the second shield connecting portion includes a first through hole, a bolt for fixing the enclosure and the second shield connecting portion being passed through the first through hole.

3. The connector of claim 2, wherein:
the terminal includes a second through hole, a terminal fixing bolt for fixing a mating terminal arranged inside the enclosure and the terminal being passed through the second through hole,
the first through hole penetrates through the second shield connecting portion in a second direction orthogonal to the first direction, and
the second through hole penetrates through the terminal in the second direction.

4. The connector of claim 2, wherein the shield shell includes a nut fixed in the first through hole and to be attached to the bolt.

5. A connector fixing structure, comprising:
an electrically conductive enclosure of a device;
a connector housing for holding a terminal and a wire electrically connected to the terminal and pulled out along a first direction; and
an electrically conductive shield shell,
the enclosure including a mounting opening, the terminal being inserted through the mounting opening, and a shield shell connecting portion provided inside the enclosure,
the connector housing including an outer arrangement portion to be arranged outside the enclosure and an inner arrangement portion to be arranged inside the enclosure,
the outer arrangement portion including a fixing portion to be fixed to an outer surface of the enclosure,
the wire being a shielded wire including a core wire, a first insulation coating covering an outer periphery of the core wire, an electrically conductive electromagnetic shield member covering an outer periphery of the first insulation coating and a second insulation coating covering an outer periphery of the electromagnetic shield member,
the shield shell including a first part to be arranged inside the outer arrangement portion and a second part to be arranged inside the enclosure together with the inner arrangement portion,
the first part including a first shield connecting portion to be electrically connected to the electromagnetic shield member, the first part covering an outer periphery of a part of the wire to be arranged inside the outer arrangement portion,
the second part including a second shield connecting portion, and
the second shield connecting portion being located inside an outer edge of the connector when viewed from the first direction, the second shield connecting portion being fixed and electrically connected to the shield shell connecting portion inside the enclosure.
